(19) United States
(12) Patent Application Publication
(10) Pub. No.: US 2013/0011228 A1
(43) Pub. Date: Jan. 10, 2013

(54) Method and Apparatus for Dry-Conveying Material for Dry Gunning Application

(75) Inventor: James W. Stendera, Burgoon, OH (US)

(73) Assignee: VESUVIUS CRUCIBLE COMPANY, Wilmington, DE (US)

(21) Appl. No.: 13/635,715

(22) PCT Filed: Mar. 16, 2011
(86) PCT No.: PCT/US2011/028633

§ 371 Date: Sep. 18, 2012

Related U.S. Application Data
(60) Provisional application No. 61/315,206, filed on Mar. 18, 2010.

(51) Int. Cl. B65G 65/48

(52) U.S. Cl. 414/325; 414/808

(57) ABSTRACT

A method and apparatus for conveying dry material for a gunning application make use of a rotary air lock in communication with a material source and an inductor. The material is supplied through the rotary air lock to the inductor under a pressure greater than the outlet pressure of the inductor.

### BACKGROUND OF THE INVENTION

1. Field of the Invention

The invention relates to the application of materials to a surface or object by projection.

2. Description of Related Art

Material feeding and depositing systems have been developed to propel and deposit materials in a desired location. These systems are used to apply, for example, cementitious and refractory materials to surfaces, especially hot surfaces that cannot be directly contacted.

Refractories are used as working linings of metal processing and transfer vessels to contain molten metal and slag and the associated heat and gases. These linings typically are consumable materials that are eroded or otherwise damaged by exposure to the conditions within the vessel. When a certain amount of consumption of or damage to the lining has occurred, metal processing must be halted--sometimes for an extended time--in order to repair or replace the refractory lining. The frequency of these interruptions is determined by the rate at which the process consumes the lining. The duration of these interruptions is dependent on the consumption rate and whether it is possible to repair localized damage to the lining without removing the undamaged portions and replacing the entire lining.

Castable refractories are formulations containing water that leaves during a curing process. Installation of a castable refractory lining requires; onsite mixing with the attendant mixing equipment, water source, skilled labor and supervision costs, and risk of mixing errors. The quality of the castable lining depends, among other things, on the casting water added, the mixing and vibration techniques used, and the skill of the installers. Transporting the mixed wet castables to the job site may be time consuming, awkward and inconvenient. Installation may require forming, which increases installation time and cost. Dryout of a castable lining at elevated temperatures is needed to remove the added moisture before the lining can be cured and placed into service. Heating of the castable refractory during dryout also increases energy costs.

Dry refractories are monolithic refractories that are handled and transported to the application point in dry powder form without the addition of water or liquid chemical binders. These materials are applied to surfaces by a propulsion technique known as dry gunning. In this technique, dry materials are propelled into place either mechanically or with the use of a gaseous propellant. The dry materials are propelled into an application lance where they are combined with water or other liquids, such as liquid chemical binders, to form a stream of wetted and mixed material that is applied to a surface or object. Use of dry materials minimizes many of the problems associated with the use of castable refractories. However, the handling and application of dry materials introduces other difficulties, such as the tendency of dry materials to segregate as is well known in the art during the conveying process and to resist moving from one part of an application apparatus to another.

One system that has been used for dry gunning includes a pressure tank, a bottom butterfly valve and an air-conveying inductor. The dry material is placed into a pressurized tank. A butterfly valve located at the bottom of the tank opens and closes to introduce portions of the dry material contained in the tank into an inductor. Compressed air in the inductor propels the dry material into place as the inductor is so constructed to create a venture effect and cause a slight negative pressure between the tank and the inside of the inductor. Smooth flow in this type of equipment is dependent on a steady pressure differential between the tank, the inside of the inductor and the line down which the material is conveyed. As any minor obstruction in the hose disrupts this pressure differential this type of equipment is prone to surging where material delivery is not uniform. This makes it difficult to maintain a consistent water addition to the material resulting in a poor patch.

Another system used for dry gunning makes use of a rotary gun. In this system, the material is fed into a jet of air by means of a wheel with cavities that are filled carousel fashion. This system can produce a more uniform feed, but the equipment is expensive and difficult to maintain as the incursion of powdered or granular materials produces wear on the apparatus between the moving plate containing the cavities and rubber gaskets that prevent air from escaping. It is critical that this system is maintained correctly or the escaping air causes dust and poor performance in the machine. In addition, due to the fact the holes are relatively small and there is a relatively small time for them to fill completely this can create non uniform feed to the point the jet propels the material down the hose.

### BRIEF SUMMARY OF THE INVENTION

Accordingly, the inventor has developed a method and apparatus for dry gunning that provides a consistent feed, provides a consistent material output, and can produce appropriate material dispensing volumes and forces without a high level of maintenance of the apparatus.

The apparatus of the invention incorporates a rotary air lock having an interior and an exterior, comprising (a) a material entry port, (b) a pressurization port, (c) an exit port, (d) a rotor capable of rotation and comprising a plurality of vanes, and (e) at least one vane pocket defined by adjacent vanes. The entry port and the exit port may be located on the circular periphery of the rotary air lock. The pressurization port is in communication with a vane pocket not in communication with the exit port of the rotating air lock. The entry port may communicate with a vessel or material container in which material is contained; this vessel may have a material container outlet that communicates with the material entry port of the rotary air lock. In one embodiment of the invention, this vessel is a pressure tank, and the vessel may be equipped with an inlet valve for pressurizing the vessel and an inlet port for introducing material to the vessel. In this embodiment, the material entry port of the rotary air lock also serves as the pressurization port; the material container outlet and the pressurization port are co-located. In another embodiment of the invention, the vessel is unpressurized and takes the form of, for example, a bin or hopper. In this embodiment, the material entry port and the pressurization port are discrete and, on rotation of the rotor, the vane pockets are consecutively a) in communication with the entry port, b) in communication with the pressurization port, and c) in communication with the exit port. The rotary air lock may also in be communication, by way of the rotary air lock exit port, with the inlet of an inductor having an inlet and an outlet. The rotary air lock includes a housing comprising at least one wall defining an interior. Within the housing interior, the vanes are fixed to a rotor that can rotate about an axis. This axis may be horizontal. The vanes are configured so that they form, during a portion of their rotation, airtight or nearly airtight contact with the housing wall. The apparatus can thus seal a pressurized system against loss of air or gas while permitting a flow of material between components with different pressures. If a pressure tank is present, the apparatus can maintain the pressure of the pressure tank to be higher than the pressure of the inductor. The apparatus is configured so that there is no direct interaction between the pressure provided through the pressurization port and the pressure within the inductor. The vane pocket can house material to be gunned. This configuration produces a uniform feed rate out of the material container and through the exit port of the rotary air lock. As the rotor rotates, material is conveyed in a vane pocket that is initially in communication with the entry port, is then isolated from the entry port and exit port, and is then in communication with the exit port.

In certain embodiments, the material to be gunned is placed in the material container, pressurized tank or otherwise disposed so that consecutive portions may be introduced into the entry port of the rotary air lock. A vane unit is fixed to the rotor and includes a plurality of vanes that define a plurality of vane pockets. The rotor is rotated, allowing dry material to move into consecutive vane pockets. Upon further rotation, the consecutive vane pockets open into the exit port. An inductor compartment may be present to receive material passing through the exit port. Alternatively, the exit port of the airlock may be in communication with a dispensing line. The pressure within a vane pocket opening into the exit port is greater than the pressure in the exit port. This pressure differential induces material to move from the vane pocket through the exit port. Without wishing to be bound by any particular theory, it is believed that the gas that is trapped between grains of the material expands, and that the force of this expansion expels the material from the vane pocket and through the exit port into the inductor. It is also believed that gravity contributes to this expulsion.

The invention may be practiced by placing dry material into a material container, then passing the dry material from the material container into a rotary air lock having an interior and an exterior, comprising (a) an entry port, (b) an exit port, (c) a rotor capable of rotation and comprising a plurality of vanes, and (d) a plurality of vane pockets disposed between vanes, then pressurizing the dry material within a vane pocket, and then passing the dry material through the exit port of the rotary air lock. On rotation of the rotor, the vane pockets are consecutively a) in communication with the opening port, b) isolated from the exterior of the rotary air lock, and c) in communication with the exit port. Pressurizing the dry material within the vane pocket may be accomplished by pressurizing the dry material within the material container, which may take the form of a tank or pressure vessel. The method may also include passing the dry material through the exit port of the rotary air lock into the inlet of an inductor having an interior, and inductor inlet and an inductor outlet, then entraining the dry material in a stream produced by a jet in communication with the interior of the inductor, and then ejecting the entrained dry material from the inductor outlet. Passing the material into the vane pocket and pressurizing the vane pocket may be accomplished separately, in which case, on rotation of the rotor, the vane pockets are consecutively a) in communication with the material entry port, b) in communication with the pressurization port, and c) in communication with the exit port, and pressurizing the dry material within the vane pocket is accomplished by pressurizing the material through the pressurization port.

The method and apparatus of the invention is suitable for the conveyance of application of dry refractories. In most cases dry refractories are conveyed thru a hose to the lance where water is added to activate the water-soluble binders that are contained therein. At the lance the turbulence of the water addition and general friction in the lance causes the water to be mixed into the material as it flows. Various devices well known in the art are used to enhance this process but none are effective unless a consistent rate of dry material flow is maintained. Once leaving the lance, the wet material is applied to surfaces either hot or cold to repair existing linings or even construct new linings. In the usual practice of the application of dry refractories, the surface to which the refractory is applied is within an unencased volume, being open to the atmosphere or open to atmospheric pressure. Refractory material is thus dispensed though the pressurization port or through a lance into a volume that is not sealed or completely enclosed. In the application of refractory within an unencased volume, the operation of the present invention does not increase the ambient pressure on the surface to which the refractory is applied.

Dry gunning can be performed with the method and apparatus of the invention with a significant improvement in the consistency of dry material feed to the lance over previous methods. The method and apparatus also enable dry gunning with a positive cutoff of dry material.

### BRIEF DESCRIPTION OF THE SEVERAL VIEWS OF THE DRAWING(S)

FIG. 1 is a schematic representation of a refractory gunning device of the prior art;

FIG. 2 is a schematic representation of a device of the present invention;

FIG. 3 is a schematic representation of a device of the present invention;

FIG. 4 is a graph of operating pressures in a prior art refractory gunning device; and

FIG. 5 is a graph of operating pressures in a refractory gunning device of the present invention.

### DETAILED DESCRIPTION OF THE INVENTION

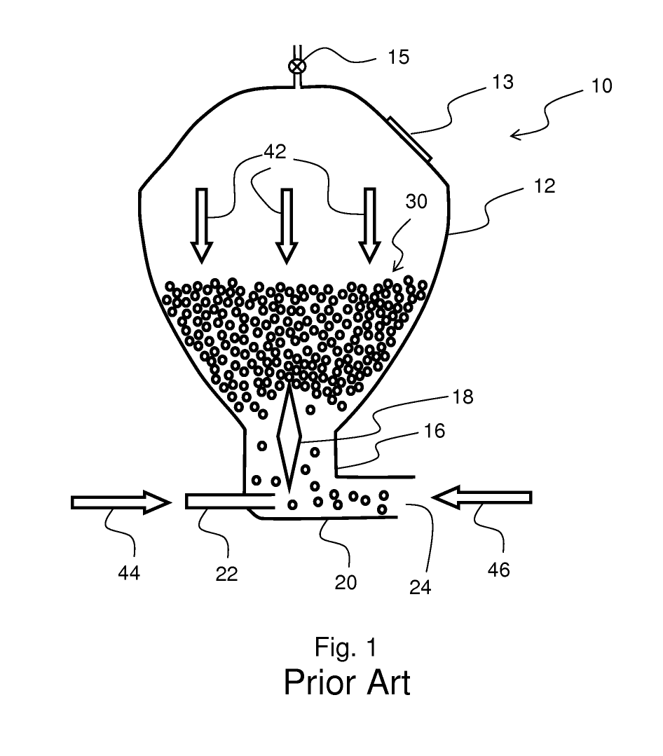

FIG. 1 shows a schematic representation of prior art dry-gunning system 10. This system contains a pressure tank 12, having a pressure tank entry port 13 through which material can be added to pressure tank 12, and pressure tank valve 15, through which pressure tank 12 can be pressurized. Pressure tank 12, is disposed in fluid connection with the inlet of a butterfly valve 16 containing butterfly valve disk 18. The outlet of butterfly valve 16 is disposed in fluid connection with inductor 20. An air jet 22 is directed into the interior of inductor 20. Inductor 20 is also provided with an inductor outlet 24.

In the standard mode of operation of dry gunning system 10, material 30 is placed inside pressure tank 12 through pressure tank entry port 13, and pressure tank 12 is pressurized through pressure tank valve 15. Butterfly valve disk 18 is opened to admit material to inductor 20. Air jet 22 expels a fluid such as air into the interior of inductor 20, entraining the material and expelling the material through inductor outlet 24 into a dispensing line, delivery line or hose by means of Venturi action, and thence to an application lance. Tank pressure 42 is exerted on material 30 within pressure tank 12. Air jet 22 exerts air jet pressure 44 on the material within inductor 20. Back pressure 46 is exerted counter to the flow of material through inductor outlet 24.

The configuration of the air jet 22 and inductor 20 is such as to set up a Venturi action and create a negative pressure in the inductor body relative to the tank, propelling the material down the line. The outlet of the jet must be placed close to the exit of the inductor. If the outlet of jet 22 is too close to inductor outlet 24, the flow of the material is greatly reduced as there is not much room between the jet and the outlet of the inductor for material to pass. If the jet 22 is placed too far from the inductor outlet 24 material is not entrained properly, negative pressure is not developed in inductor 20, and turbulence within inductor 20 restricts flow. The need for precise positioning of the outlet of jet 22 is a disadvantage of this device.

Butterfly valve 16, when open, permits direct fluid communication between the interior of pressure tank 12 and inductor 20, so tank pressure 42 and back pressure 46 tend to equalize. Eventually, to get material 30 to feed into inductor 20, air must be injected into pressure tank 12 to maintain a flow of material 30 out of pressure tank 12 into inductor 20. The delivery rate of material to inductor 20 depends directly on keeping a consistent and slightly lower pressure in the tank than in the hose. This is determined by the difference between tank pressure 42, and back pressure 46 and Venturi effect of the jet acting in inductor 20. Any disruption to this difference causes a variation in the dry flow rate of the material out of the equipment.

Many variables affect back pressure 46 in the dispensing line and inductor 20, and it is a practical impossibility to keep back pressure 46 perfectly uniform during operation. If there is a partial clog in the dispensing line or other circumstance that increases back pressure 46, an equilibration of back pressure 46 and tank pressure 42 will lead to an increase in tank pressure 42, which will reduce the amount of material 30 fed into inductor 20 unless jet pressure 44 is increased. Because tank 12 is a relatively large reservoir, the pressure increase is relatively slow, because a large volume of air must be injected into tank 12 before the pressure in the dispensing line is increased. When the clog is blown out, the rate of expulsion of air from the tank increases, increasing material flow until the pressure equilibrate. Alternating clogs and clog clearances often produce a sinusoidal pattern in the material delivery rate. There are many causes of partial clogs in equipment of this design, and the resulting pressure surges yield a highly variable feed rate of material through the dispensing line. In more severe cases the dispensing line may become plugged. In less severe cases, the result is poor application of material at the lance.

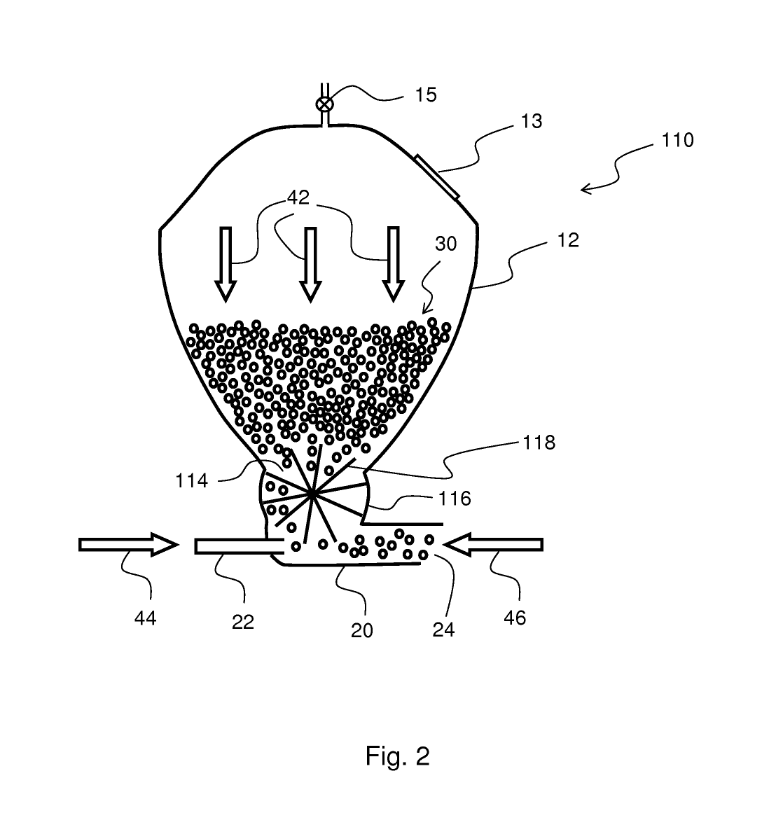

FIG. 2 provides a schematic representation of an apparatus 110 according to the present invention. This system contains a pressure tank 12, having a pressure tank entry port 13 through which material can be added, and pressure tank valve 15, through which pressure tank 12 can be pressurized. Pressure tank 12 is disposed in fluid connection, through material entry port 114, with the inlet of a rotary airlock valve 116 containing a plurality of vanes 118. Pockets for conveying material from the pressure tank 12 to inductor 20 are formed between adjacent vanes 118. The outlet of rotary airlock valve 116 is disposed in fluid connection with inductor 20. An air jet 22 is directed into the interior of inductor 20. Inductor 20 is also provided with an inductor outlet 24. In this embodiment, material entry port 114 also serves as pressurization port for material introduced into rotary air lock valve 116.

In the standard mode of operation of dry gunning system 110, material 30 is placed inside pressure tank 12 through pressure tank entry port 13. Pressure tank 12 is pressurized through pressure tank valve 15. Air jet 22 is pressurized. Rotary air lock 116 is then started, and meters material through material entry port 114 and into inductor 20. Air jet 22 in the inductor blows the material through inductor outlet 24 into a dispensing line, delivery line or hose, and thence to an application lance. Tank pressure 42 is exerted on material 30 within pressure tank 12. Air jet 22 exerts air jet pressure 44 on the material within inductor 20. Back pressure 46 is exerted counter to the flow of material through inductor outlet 24. The rotary air lock 116 in this device impedes air flow between pressure tank 12 and inductor 20, so that it is easier to maintain a desired difference in pressure. In a variation of this embodiment, either or both of inductor 20 and air jet 22 are not present and rotary air lock 116 feeds material directly into a dispensing line, delivery line or hose, and thence to an application lance.

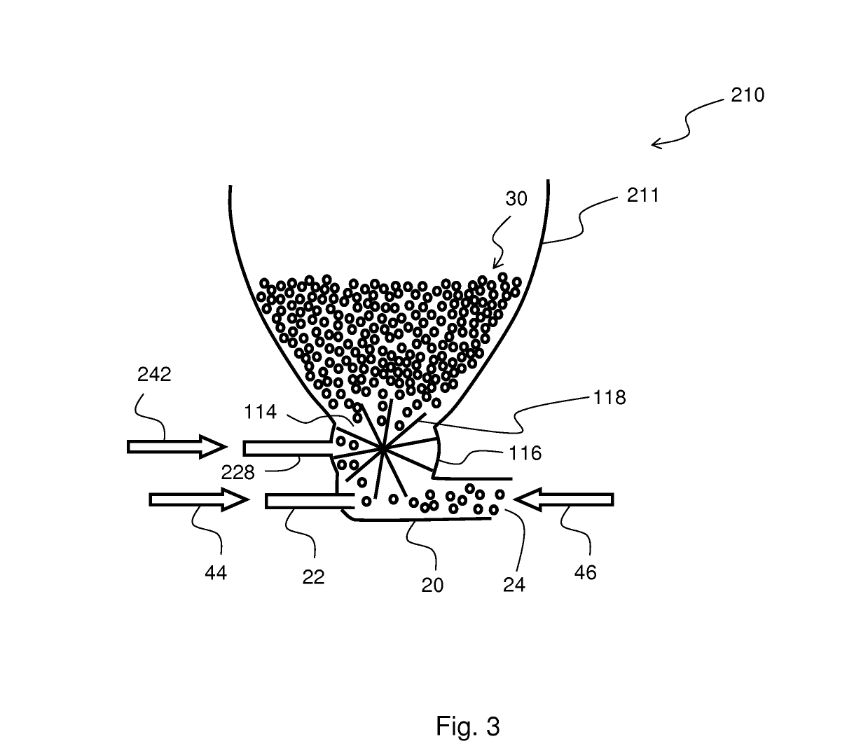

FIG. 3 provides a schematic representation of an apparatus 210 according to the present invention. This system contains a container 211 into which material 30 is placed. Container 211 is disposed in fluid connection, through material entry port 114, with the inlet of a rotary airlock valve 116 containing a plurality of vanes 118. Pockets for conveying material from container 211 to inductor 20 are formed between adjacent vanes 118. Airlock pressurization port 228 is disposed so that it is in fluid contact with a vane pocket that is not in fluid contact with material entry port 114 or inductor 20. The outlet of rotary airlock valve 116 is disposed in fluid connection with inductor 20. An air jet 22 is directed into the interior of inductor 20. Inductor 20 is also provided with an inductor outlet 24.

In the standard mode of operation of dry gunning system 210, material 30 is placed in container 211. Airlock pressurization port 228 is pressurized. Air jet 22 is pressurized. Rotary air lock 116 is then started, and meters material, through material entry port 114, into vane pockets between adjacent vanes 118. After material 30 enters a vane pocket through material entry port 114 and the vanes rotate, the vane pocket is pressurized through rotary airlock pressurization port 228. Additional rotation of the vanes places the vane pocket into communication with inductor 20, and the material is expelled into the inductor. Air jet 22 in inductor 20 blows the material through inductor outlet 24 into a dispensing line, delivery line or hose, and thence to an application lance. Pressurization port pressure 242 pressurizes individual vane pockets after material enters, after the vane pocket is isolated from material entry port 114 and before the vane pocket opens to inductor 20. Air jet 22 exerts air jet pressure 44 on the material within inductor 20. Back pressure 46 is exerted counter to the flow of material through inductor outlet 24. The rotary air lock 116 in this device impedes air flow between airlock pressurization port 228 and inductor 20, making it possible to maintain a desired difference in pressure. In a variation of this embodiment, either or both of inductor 20 and air jet 22 are not used, and rotary air lock 116 feeds material directly into a dispensing line, delivery line or hose, and thence to an application lance.

The rotary air lock used in the present invention is a device, also known as a rotary feeder or rotary valve, that may serve as a component in a bulk or specialty material handling system. Components of a rotary feeder include a rotor shaft, housing, head plates, and packing seals and bearings. Rotors typically have large vanes cast or welded on. A rotary air lock is configured so that material can be conveyed from an entry port to an exit port while a pressure seal between the entry port and the exit port is maintained at all times.

To feed material into the inductor, air is injected into the top of the pressure tank and the rotary air lock is operated. Material exits or drops from the compartments of the vanes of the rotary air lock as they are opened to the inductor as long as the tank pressure exceeds the pressure in the inductor. The delivery rate of material to the inductor is controlled by the rotational speed of the airlock. An increase in rotation rate causes an increase in the feed rate to the inductor. In general as long as the tank pressure is maintained higher than the inductor pressure the diameter of the discharge opening is the limiting factor in the feed rate of the device.

Many variables influence back pressure on the dispensing or delivery line, so it is a practical impossibility to keep a perfectly uniform back pressure during operation. However, the device of the present invention provides a more regular, and more controllable, feed rate that prior art devices. If there is a partial clog in the dispensing or delivery line, or other occurrence that increases the back pressure, the rotary air lock prevents free flow from the inductor into the tank, or any effect of inductor pressure on pressurization port pressure, and the pressure in the line increases almost instantaneously. As long as the tank pressure or pressurization port pressure is maintained above the back pressure, material will still leave or drop from the pockets of the rotary air lock, and the feed rate is not significantly changed. Additionally, since there is no large reservoir of air that has to be pressurized the line pressure increases quickly blowing the clog out quickly.

The dry-gunning system of the present invention, having a rotary air lock and a mechanism for supplying material under pressure to the rotary air lock, offers a number of advantages:

a) The feed rate of the dry material is significantly more uniform in the system of the present invention than in prior art systems for a given change in back pressure.

b) The feed rate of the system of the present invention is controlled by the rotational speed of the rotary air lock rather than by the balance of tank pressure and back pressure, as is the case with prior art systems. With the system of the present invention, a desired feed rate can be obtained easily and reproducibly for a given jet pressure, and delivery rate and delivery force of the material can be controlled.

c) In the system of the present invention, the rotary air lock makes it easier to maintain pressure balances, so that smooth flow can be obtained at substantially higher flow rates than in prior art systems.

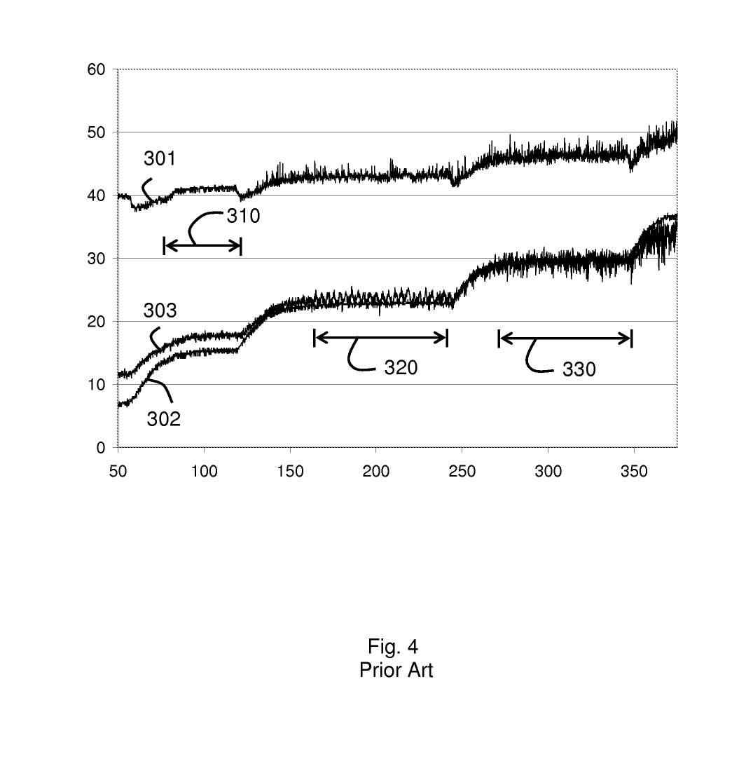

FIG. 4 depicts information collected during the operation of a dry-gunning system of the prior art in which material is placed in a pressure tank and is admitted to an inductor through a butterfly valve. The jet was adjusted with the butterfly closed to maximize the Venturi effect in the inductor. The abscissa or horizontal axis of the plot represents time in seconds; the ordinate or vertical axis represents pressure in pounds per square inch. Jet pressure 301, tank pressure 302 and hose pressure 303 are represented as a function of time. Hose pressure 303 was measured in a hose attached to the inductor outlet, and was measured 12 inches downstream from the inductor jet. Interval 310 represents a time period during which 65 pounds per minute (490 g/sec) of material were delivered. Interval 320 represents a period of time during which 145 pounds per minute (1100 g/sec) of material were delivered. Interval 330 represents a period of time during which 255 pounds per minute (1900 g/sec) of material were delivered.

In the trial depicted in FIG. 4, smooth delivery of the dry material occurred only with the lowest delivery rate of 65 pounds per minute (490 g/sec) , as represented in interval 310. In this portion of the trial, the tank pressure 302 was lower than the hose pressure 303 due to the Venturi effect of the jet in the inductor. Proper operation is obtained with a pressure differential of about two pounds negative between the inductor and the hose; i.e., inductor pressure is lower than hose pressure. Hose pressure is greater than tank pressure if the operation is smooth. If the tank pressure becomes higher than the hose pressure too much material is fed and the system clogs. To a degree, the system is self-regulating, but the self-regulation process can lead to a cyclic variation in material delivery rate. The pressure in the interior of the inductor is lower than the tank pressure; otherwise, material would not flow from the tank.

In interval 320 in FIG. 4, at a feed rate of 145 pounds per minute (1100 g/sec), the hose pressure 303 cycles up and down in a rhythmic pattern that is indicative of the undesirable phenomenon of surging. Surging is an oscillation, in the quantity of the material delivered, having a period long enough to interfere with the material's optimum delivery. The rhythmic pattern shown in interval 320 has a period of about four seconds and is typical of surging. When the back pressure from the hose pressure 303 increases, the tank pressure 302 increases to compensate, as jet pressure 301 is much higher than either tank pressure 302 or hose pressure 303. As this happens, material flow into the inductor slows, which in turn reduces the back pressure. A reduction in back pressure increases material flow to the inductor, which causes back pressure to increase and the cycle to start again. At this rate of flow, application of material is still possible but not optimal. Addition of water to the material is complicated by surging, but can still be accomplished if the surging cycle is regular and has a short enough period.

In interval 330 in FIG. 4, at a higher feed rate of 255 pounds per minute (1900 g/sec), the cycles become more chaotic and have a longer period. There are longer periods of time during which the hose pressure is above the tank pressure. At this feed rate the gunning is completely unstable with periods of very dry and very wet material. Application of a quality patch of refractory material cannot be carried out.

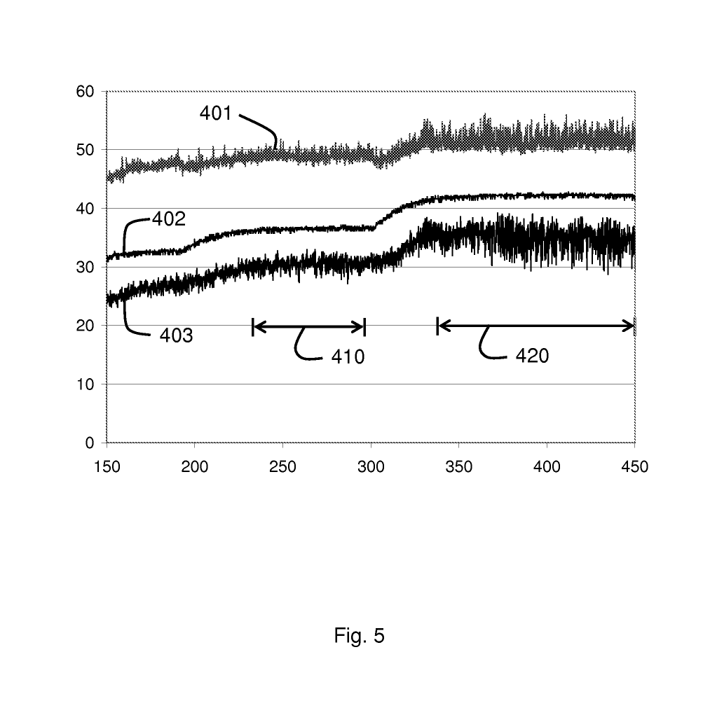

FIG. 5 depicts information collected during the operation of a dry-gunning system of the present invention in which material is placed in a pressure tank and is admitted to an inductor through a rotary air lock. The abscissa or horizontal axis of the plot represents time in seconds; the ordinate or vertical axis represents pressure in pounds per square inch. Jet pressure 401, tank pressure 402 and hose pressure 403 are each represented as a function of time. Hose pressure 403 was measured in a hose attached to the inductor outlet, and was measured 12 inches (30 cm) downstream from the inductor jet. Interval 410 represents a time period during which 155 pounds per minute (1200 g/sec) of material were delivered. Interval 420 represents a period of time during which 265 pounds per minute (2000 g/sec) of material were delivered.

In the trial depicted in FIG. 5, the tank pressure 402 is always greater than the hose pressure 403. This is the result of the isolation of the inductor from the pressure tank by the rotary air lock. When a pocket in the rotary air lock opens into the inductor, the higher air pressure in the pocket ensures that the material in the pocket will be emptied into the inductor. At the 155 pound per minute (1200 g/sec) delivery rate in interval 410, the pressure plots are relatively smooth and do not exhibit the cyclic pattern seen in FIG. 4 for the prior art dry-gunning system. At the 265 pound per minute (2000 g/sec) delivery rate there is no regular cyclic pattern of the hose pressure. The chaotic increases and decreases are due to the random small variations routinely seen during the gunning process. The amplitude of these variations is seen to be higher than with prior art equipment due to the fact that, in the device of the present invention, there is no open connection between the inductor and the tank. The tank can therefore act as a reservoir damping out pressure increases. Small clogs are blown out quickly before they can disrupt the gunning process. Water addition to the material even at this increased rate was much more consistent and material application was as good as, or better than, that achieved by the prior art system at the 145 pound per minute (1100 g/sec) rate.

The device and process of the present invention can be configured in various ways and operated under various conditions. It has been found that the device and process of the present invention according to FIG. 3 are able to deliver 155 lbs (70 kg) of refractory material per minute (1200 g/sec) through a 1.5 inch (3.8 cm) diameter dispensing line or hose at a 24 psi (pounds per square inch) (170 kPa) hose pressure, a 26 psi (180 kPa) tank pressure, and a 47 psi (324 kPa) jet pressure. The device and process of the present invention according to FIG. 3 are also able to deliver 265 lbs (120 kg) of refractory material per minute through a 1.5 inch (3.8 cm) diameter dispensing line or hose at a 33 psi (230 kPa) hose pressure, a 35 psi (240 kPa) tank pressure, and a 47 psi (320 kPa) jet pressure. The tank, or the vane pocket containing the dry material, is capable of being maintained, and may be maintained, at a pressure 0.5 to 10 psi (3 kPa to 69 kPa) greater than the inductor pressure, 1 to 5 psi (7 kPa to 34 kPa) greater than the inductor pressure, 1.5 to 3.5 psi (10 kPa to 24 kPa) greater than the inductor pressure, or 2 to 3 psi (14 to 21 kPa) greater than the inductor pressure. A hose or dispensing line pressure that is in the range of 0.3 to 0.7 times the jet pressure, or 0.5 to 0.7 times the jet pressure, can be obtained with the device and process of the present invention. The device and process of the present invention are able to deliver 155 pounds (70 kg) of refractory material per minute through a 1.5-inch (3.8 cm) diameter dispensing line or hose with a hose pressure that varies by no more than 8%. The device and process of the present invention are able to deliver 155 pounds (70 kg) of refractory material per minute through a 1.5-inch (3.8 cm) diameter dispensing line or hose without exhibiting a cyclic pattern of delivery or surging.

Numerous modifications and variations of the present invention are possible. It is, therefore, to be understood that within the scope of the following claims, the invention may be practiced otherwise than as specifically described.

1. A device, having an interior and an exterior, for conveying material for dry gunning applications, comprising:
a material container, having a material outlet, and
a rotary air lock having an interior and an exterior, comprising (a) a material entry port, (b) a pressurization port, (c) an exit port, (d) a rotor capable of rotation and comprising a plurality of vanes, and (e) a plurality of vane pockets disposed between vanes, wherein
the material outlet of the material container is in communication with the material entry port of the rotary airlock, and
the pressurization port is in communication with a vane pocket not in communication with an exit port of the rotary air lock;
wherein the exit port is in fluid communication with the exterior of the device.

2. The device of claim 1, wherein, on rotation of the rotor, the vane pockets are consecutively a) in communication with the material entry port, b) in communication with the pressurization port, and c) in communication with the exit port.

3. The device of claim 1, wherein the material container is a pressure tank, and the material outlet and the pressurization port are co-located.

4. The device of claim 3, wherein, on rotation of the rotor, the vane pockets are consecutively a) in communication with the opening port, b) isolated from the exterior of the rotary air lock, and c) in communication with the exit port.

5. The device of claim 1, wherein the exit port of the airlock is in communication with an inductor.

6. The device of claim 1, wherein the exit port of the airlock is in communication with a dispensing line.

7. The device of claim 5, wherein the vane pocket in communication with the pressurization port is capable of being maintained at a pressure 0.5 to 10 pounds per square inch greater than the pressure of the inductor.

8. The device of claim 5, wherein the vane pocket in communication with the pressurization port is capable of being maintained at a pressure 1.5 to 3.5 pounds per square inch greater than the pressure of the inductor.

9. A method for conveying material for dry gunning applications, comprising placing dry material into a material container,
passing a dry material from a material container into a rotary air lock having an interior and an exterior, comprising (a) an entry port, (b) an exit port, (c) a rotor capable of rotation and comprising a plurality of vanes, and (d) a plurality of vane pockets disposed between vanes,
pressurizing the dry material within a vane pocket, and
passing the dry material through the exit port of the rotary air lock;
wherein the exit port of the rotary air lock is in fluid communication with the exterior of the air lock.

10. The method of claim 9, further comprising
passing the dry material through the exit port of the rotary air lock into the inlet of an inductor having an interior, an inductor inlet and an inductor outlet, and
entraining the dry material in a stream produced by a jet in communication with the interior of the inductor, and
ejecting the entrained dry material from the inductor outlet.

11. The method of claim 9 wherein, in the device, on rotation of the rotor, the vane pockets are consecutively a) in communication with the material entry port, b) isolated from the exterior of the rotary air lock, and c) in communication with the exit port.

12. The method of claim 9 wherein pressurizing the dry material within the vane pocket is accomplished by pressurizing the dry material within the material container.

13. The method of claim 9 wherein, on rotation of the rotor, the vane pockets are consecutively a) in communication with the material entry port, b) in communication with the pressurization port, and c) in communication with the exit port, and
wherein pressurizing the dry material within the vane pocket is accomplished by pressurizing the dry material through the pressurization port.

14. The method of claim 10, wherein the vane pocket containing the dry material is maintained at a pressure 0.5 to 10 pounds per square inch greater than the pressure of the inductor.

15. The method of claim 10, wherein the vane pocket containing the dry material is maintained at a pressure 2.5 to 3.5 pounds per square inch greater than the pressure of the inductor.
